(19) United States
(12) Patent Application Publication
(10) Pub. No.: US 2026/0147655 A1
(43) Pub. Date: May 28, 2026

(54) REAL-TIME ALERTING AND CORRELATION OF INGESTED DATA

(71) Applicant: Cisco Technology, Inc., San Jose, CA (US)

(72) Inventors: Subramaniam Baskaran, Foster City, CA (US); Abhijit Bhave, Dublin, CA (US); Ramkumar Chandrasekharan, Saratoga, CA (US); Michael Margulis, Danville, CA (US); Rehan Salman Mulla, Fremont, CA (US)

(21) Appl. No.: 18/960,520

(22) Filed: Nov. 26, 2024

(51) Int. Cl. G06F 11/07

(52) U.S. Cl. CPC G06F 11/0769; G06F 11/0721

(57) ABSTRACT

Alerts can be generated and transmitted to one or more recipients before the data associated with the alert is indexed. In some examples, a computer system comprising one or more data processing systems, generates an alert object based on data received a data source. The computing system transmits an alert based on the alert object to a user device and correlates the alert object with indexed data related to the alert source or other data generated after generating the alert object. The computer system also populates and displays the dashboard with the correlated data.

### BACKGROUND

The ever-increasing complexity of software applications has made it very difficult to quickly diagnose problems when something goes wrong in an application. The increase in complexity is driven by adoption of new architectures, such as distributed microservices-based architectures, and more complex front-end and back-end implementations. Customers and users of these applications are, however, demanding better performance from these applications and performance problems (e.g., slow responsiveness, errors, down times) with an application can cause to users stop using the application and use an alternative instead. Providers of software applications thus need tools that facilitate performance monitoring of the software applications, early identification of any problems, and quick resolution of any problems.

In some cases, observability systems are configured to facilitate monitoring of software applications and analysis of the data captured from the monitoring. For example, an observability system configured to monitor the performance of a software application may monitor and receive data related to the execution of the software application, perform analysis of the received data, generate actionable data, output the analyses results via dashboards, etc. These dashboards can then be used by providers of the software application, site reliability engineers (SREs), and others to detect any performance issues with the software application and take steps to remediate the detected problems or issues.

### BRIEF DESCRIPTION OF THE DRAWINGS

Illustrative examples are described in detail below with reference to the following figures:

FIG. 1 shows an example of a system for detecting and transmitting alerts before data is available within a data platform, according to at least one implementation.

FIG. 2 illustrates a block diagram of a trace analysis environment, according to at least one implementation.

FIG. 3 is a flowchart illustrating an example process for real-time alerting and correlating ingested data, according to at least one implementation.

FIG. 4 is a flowchart illustrating an example process for updating a dashboard, according to at least one implementation.

FIG. 5 is a block diagram illustrating an example computing environment that includes a data intake and query system, according to at least one implementation.

FIG. 6 is a block diagram illustrating in greater detail an example of an indexing system of a data intake and query system, such as the data intake and query system of FIG. 5, according to at least one implementation.

FIG. 7 is a block diagram illustrating in greater detail an example of the search system of a data intake and query system, such as the data intake and query system of FIG. 5, according to at least one implementation.

FIG. 8 illustrates an example of a self-managed network that includes a data intake and query system, according to at least one implementation.

### DETAILED DESCRIPTION

Examples are described herein in the context of techniques for real-time alerting and analytics of correlated data ingested by a computer system. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

Described herein are techniques related to providing real-time alerts from one or more alert sources and providing analytics relating to the alerts. As used herein, an “alert source” is any hardware and/or software that provides data that indicates an occurrence of an alert. Generally, an “alert” is triggered when one or more specified condition(s)/threshold(s) are met. For example, an alert source may include but is not limited to a data source such as an application, a service, a system and/or some other component or device that is being monitored.

According to some examples, the alert source provides data to a computing environment, such as a data intake and query system (DIQS), that ingests and analyzes the data. Generally, a DIQS, which may also be referred to herein as a “data platform” can ingest, and store data obtained from components in a computing environment, and can enable an entity to search, analyze, and visualize the data. Through these and other capabilities, the data platform can enable an entity to use the data for administration of the computing environment, to detect security issues, to understand how the computing environment is performing or being used, and/or to perform other analytics.

Prior to techniques described herein, alerts could take many minutes to detect due, at least in part, to latency introduced by the ingestion and indexing of data received by a data platform. For instance, today's information technology (IT) systems can produce large data volumes that require complex processing and correlation that can result in delays associated with determining that an alert has occurred. Scale and complexity can also stress a search architecture of the data platform that results in latency in the alert processing life cycle. Latency in alert processing in turn has a direct impact on increasing customer mean time to repair.

Using techniques described herein, instead of having to wait minutes to be able to determine an occurrence of an alert, alerts are provided to one or more alert destinations in real-time or near real-time, before the data is ingested and indexed by a data platform. In some configurations, an alert hub performs processing that determines whether the incoming data from the data source (e.g., to be ingested and indexed) indicates an alert. In contrast to waiting to ingest and index the data, and then determining whether an alert has occurred, an alert is generated (e.g. in near real-time) by the alert hub and transmitted to one or more alert destinations before the data is made available (e.g., after ingesting and indexing) by the data platform. As such, one or more users, systems, and/or services can be notified of the alert in near real-time (e.g., less than a minute) before the time the alert would be indicated within the data platform (e.g., 3 minutes, 3-6 minutes, 4-20 minutes, . . . ).

According to some configurations, an alert hub receives data that is directed to the data platform for ingesting and indexing. The alert hub analyzes the received data to identify an alert. In some examples, the alerts may be identified based on the data matching one or more specified conditions. The alert hub can be configured to identify different types of alerts that are well known (e.g., based on a source, follows a particular format, . . . ), analyze one or more events (e.g., a chain of events) to determine an alert, and the like. After identifying an alert within the data, the alert hub generates an alert object.

According to some examples, an “alert object” is a data structure that normalizes alerts detected from data received from different alert/data sources (e.g., systems, services, applications, components, . . . ). Stated another way, the alert hub generates an alert object that follows a common/standardized alert format regardless of the alert/data source that provided the data that indicated the alert. In some examples, the alert hub generates the alert object from the data directed to the data platform (e.g., in-stream) but before waiting for the data platform to ingest and index the data, thereby providing the alert to one or more alert destinations in near real-time. In this way, users are notified in advance of the data becoming available within the data platform that can be used to determine a root cause that caused the alert.

An advantage of normalizing/standardizing the alerts received from different alert sources is that a user, or some other device/component, does not need to perform special processing to identify an alert. Instead, the alert hub can identify the alert within the data received by the data platform. Additionally, by not having to wait to perform correlation searches using the ingested data to detect an alert, the alert hub eliminates correlation searches, and instead uses in-stream enrichment to generate near real-time alerts. This can significantly reduce the total time from ingesting the data to detecting an alert (e.g., from 5-15 minutes to about 1 minute). Further, instead of having to access different systems, users can use the same system to receive real-time alerts and determine a root cause of the alert using the analytics provided by the data platform.

In contrast to existing techniques in which an application/service/system provides an alert to an alert destination, alerts can be routed to an alert destination by an alert hub that receives data for ingestion into a data platform. According to some configurations, an alert can be modified before it is delivered to the determined destination. The processed alert can then be provided to a user. Once the alert is delivered (or at some other specified time), the alert hub marks the alert as consumed. In some examples, once the alert is marked as consumed, the alert is prevented from being modified. A search, however, can be used to locate an alert. After some period, the alert can be deleted or archived. In some examples, the alert can cause an automated process to be performed (e.g., cause a playbook to be activated, restart a system, change a parameter, and the like).

In some configurations, an alert object can be correlated with data ingested by the data platform. According to some examples, the alert is correlated with traces, log data, historical data, and/or other data. For instance, when the ingested data associated with the alert object becomes available within the data platform, the data platform, or some other component/device, can correlate the alert object with the ingested data (e.g., log data and/or trace data) and/or other data that is related to the alert object (e.g., the data can be used to determine analytics associated with a cause of the alert). According to some configurations, the data platform analyzes the ingested data to assist in identifying a root cause for the alert.

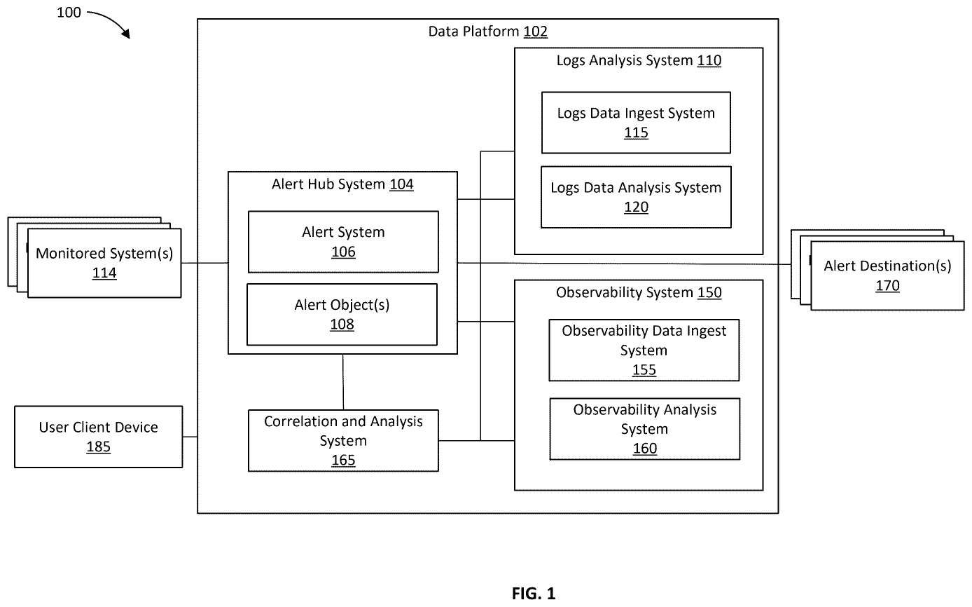

In some configurations, an observability system (such as the observability system illustrated in FIG. 1) can offer a unified environment to monitor infrastructure, applications, and supporting services in real-time, in a single pane of glass. The platform can integrate with common data sources to get data from on-premise and cloud infrastructure, applications and services, and user interfaces into the observability system. In some examples, the observability system can transform raw metrics, traces, and logs into actionable insights in the form of dashboards, visualizations, alerts, and more. The features of the observability system can enable users to quickly and intelligently respond to outages and identify root causes, while also giving users the data-driven guidance needed to optimize performance and productivity.

Additionally, in certain examples, the observability system can receive data from a user's environment using supported integrations to common data sources. The observability system can offer insights into infrastructure as well as the ability to perform powerful, capable analytics infrastructure and resources across hybrid and multi-cloud environments. Infrastructure monitoring offers support for a broad range of integrations for collecting all kinds of data, from system metrics for infrastructure components to custom data from applications.

Further, in certain examples, the observability system can collect traces and spans to monitor distributed and/or non-distributed applications. A trace is a collection of actions, or spans, that occur to complete a transaction. Examples of this trace data may include distributed trace data, stack trace data, etc. In some configurations, the observability system can collect and analyze every span and trace from each of the services connected to the observability system to give users full-fidelity access to all of their application data (e.g., as opposed to a sample-based approach). Of course, however, sampling may be performed with the observability system collecting and analyzing a subset of spans and/or traces from each of the connected services.

Also, results of either of these analysis techniques (full-fidelity or sampled) may be used to generate one or more metrics for display on interfaces such as dashboards. Traces and spans may also be conceptually linked to logs, infrastructure status information, etc. Further still, in some examples, each instance of trace data may include a plurality of spans, where each span may indicate an individual unit of work performed during a particular transaction. In some examples, each span may be provided with associated tags. For example, these tags may include data such as a unique span identifier (ID), a service name, an operation name, a duration (e.g., a latency between the sending of a query to a database and the receipt of a response from the database), start and end timestamps, a location/region, etc.

The following sections describe various non-limiting examples and embodiments incorporating the teachings described in this disclosure. FIG. 1 shows an example of a system 100 for detecting and transmitting alerts before data is available within a data platform, according to some examples of the present disclosure. System 100 includes a data platform that includes an alert hub system 104 (which may be referred to herein as an “alert hub”), a log analysis system 110, and an observability system 150.

The log analysis system 110 can include components for ingesting and processing logged data from various sources. The observability system 150 can include components for real-time monitoring and visualization of data obtained from various sources. In system 100, the alert hub system 104, the log analysis system 110, and the observability system 150 are shown as receiving data from monitored systems 114. The monitored systems 114 may be different data sources (e.g., applications, services, hardware/software components, . . . ). For example, monitored systems 114 may include but is not limited to a data source such as an application, a service, a system and/or some other component or device that is being monitored.

The monitored systems 114 may also generate alerts and/or data indicating an alert. In various examples, the alert hub system 104, the log analysis system 110, and the observability system 150 can receive data from different monitored systems 114, the same monitored systems 114, or a combination of both.

The system 100 may be implemented using one or more data processing systems and computing devices. As shown, the observability system 100 comprises multiple systems and systems that are communicatively coupled to each. Importantly, system 100 depicted in FIG. 1 is merely an example and is not intended to unduly limit the scope of claimed embodiments. Many variations, alternatives, and modifications are possible. For example, in some implementations, the system 100, including the log analysis system 110 and the observability system 150, may have more or fewer systems or systems than those shown in FIG. 1, may combine two or more systems or systems, or may have a different configuration or arrangement of systems or systems. The systems, systems, and other components depicted in FIG. 1 may be implemented in software (e.g., code, instructions, program) executed by one or more processing units (e.g., processors, cores) of the respective systems, using hardware, or combinations thereof. The software may be stored on a non-transitory storage medium (e.g., on a memory device) and executed by one or more processors of the system 100.

In certain implementations, the system 100 may be implemented in a cloud environment using infrastructure provided by a cloud service provider (CSP). In such an embodiment, the functions performed by the observability system 100 and described in this disclosure may be offered via a cloud service to one or more customers subscribing to the cloud service. For example, either or any of the alert hub system 104 log analysis system 110 and the observability system 150 may be offered as a cloud service to a customer. In some examples, a private instance, or tenancy, can be created for the customer in which some or all of the components of the system 100 may be isolated or otherwise configured for the exclusive use of the customer.

The observability system 150 includes an observability data ingest system 155 that receives data from the monitored systems 114. For example, the observability data ingest system 155 can receive raw or pre-processed telemetry data from the monitored systems 114, including metrics, logs, or traces. In some examples, the observability data ingest system 155 can apply further pre-processing to received data prior to storing the received data in a suitable data store (not shown) to be used for generation of analytics, dashboards, reports, and so on.

The various operations that the observability system 150 can perform using the received data, as well as other associated functionality, are represented by the observability analysis system 160. Example operations include charting, listing, statistical analysis of time-series data, profiling, or auto-correlation of metrics, among many others. The observability analysis system 160 can provide access to the operations via a UI frontend such as a web application in concert with a web-based API. Alternatively, some client devices can access the observability analysis system 160 directly using a web-based API.

In a similar fashion, the log analysis system 110 includes a logs data ingest system 115 and a logs analysis system 120. The logs data ingest system 115 can receive raw data or pre-processed data from the monitored systems 114 and tasks such as parsing or initial processing of log streams. In analogy to the observability analysis system 160, the logs analysis system 120 can perform operations such as log analytics, text search, clustering, and statistical analysis, and so on. The logs analysis system 120 can likewise provide access to the operations via a UI frontend such as a web application in concert with a web-based API. Alternatively, some client devices can access the logs analysis system 120 directly using a web-based API. The UI and/or API used may be the same as the ones used by the observability analysis system 160 or they may be different. As will be discussed in more detail below, the correlation and analysis system 165 may access logs data, observability data, and/or other data (e.g. historical data) to determine data that is correlated with one or more alerts.

A user client device 102 can access the alert hub 104, the logs analysis system 110 and/or the observability analysis system 150. The user client device 102 can be any suitable device or computing system for accessing the logs analysis system 110 and/or the observability analysis system 150 such as a laptop, desktop, smartphone, tablet, etc. The user client device 102 can be used, for example, to access a GUI or API provided by the logs analysis system 110 and/or the observability analysis system 150.

As briefly discussed above, in some examples, the alert hub 104 is configured to provide real-time (or near real-time alerts such as less than about one minute) alerts from one or more alert sources, such as monitored systems 114, and providing correlated data associated with alert and/or analytics relating to the alerts.

As briefly discussed above the data platform 102 can ingest, and store data obtained from components in a computing environment, and can enable an entity to search, analyze, and visualize the data. Among other users, the data platform 102 can enable an entity to use the data for administration of the computing environment, to detect security issues, to understand how the computing environment is performing or being used, and/or to perform other analytics.

As briefly discussed above, prior to techniques described herein, alerts could take many minutes to detect and deliver to an alert destination due, at least in part, to latency introduced by the ingestion and indexing of data received by a data platform 102. Using techniques described herein, instead of having to wait minutes to be able to determine and receive notification of an alert, the alert hub 104 detects and provides alerts to one or more alert destinations 170 before the data is ingested and indexed by a data platform 102.

In some configurations, the alert hub 104 performs processing that determines whether the incoming data from a data source, such as a monitored system 114 indicates an alert. In contrast to waiting for the ingested data to become available after ingestion and indexing, an alert is generated (e.g. in near real-time) by the alert hub 104 and transmitted to the one or more alert destinations 170 before the data is made available (e.g., after ingesting and indexing) by the data platform 102. As such, one or more users, systems, and/or services can be notified of the alert in near real-time (e.g., less than a minute) before the time the alert would be indicated within the data platform (e.g., 3 minutes, 3-6 minutes, 4-20 minutes, . . . ).

According to some configurations, the alert hub 104 receives data from monitored systems 114 that is directed to the data platform 102 for ingesting and indexing. The alert hub 104 analyzes the received data to identify an alert. In some examples, the alerts may be identified based on determining that the data matches one or more specified conditions. According to some configurations, the alert hub 104 identifies different types of alerts that are well known (e.g., based on a source, follows a particular format, . . . ), analyzes one or more events (e.g., a chain of events) to determine an alert, and the like. After identifying an alert within the data, the alert hub 104 generates an alert object.

According to some configurations, after detecting/determining an alert, the alert hub 104 generates the alert object 108. The “alert object” 108 is a data structure that normalizes alerts detected from data received from different alert/data sources (e.g., systems, services, applications, components, . . . ). Stated another way, the alert hub 104 generates an alert object 108 that follows a common/standardized alert format regardless of the alert/data source that provided the data that indicated the alert. In some examples, the alert hub 104 generates the alert object 108 from the data received from the monitored systems 114 directed to the data platform (e.g., in-stream) but before waiting for the data platform 102 to ingest and index the data, thereby providing the alert object 108 to one or more alert destinations 170 in near real-time. In this way, users are notified in advance of the data becoming available within the data platform that can be used to determine a root cause that caused the alert.

An alert object 108 may have different fields used during the processing/handling of the alert. For example, an alert object 108 may include an identifier (e.g., a globally unique identifier (GUID)), information identifying a source of the alert, information identifying one or more alert destinations 170 to transmit an alert, a status of the alert, time information related to the alert, as well an option to provide additional information along with an alert. According to some configurations, the alert object 108 can be automatically tagged with system and other information before being delivered to one or more alert destinations. In some cases, an alert object 108 may be modified such as but not limited to performing operations (e.g., add modifiers, add application specific data, different applications can interact with the same alert object, add a field, perform some operation, . . . ).

Another advantage of normalizing/standardizing the alerts received from different alert sources (e.g., monitored systems 114) is that a user, or some other device/component, does not need to perform special processing to identify an alert. Instead, the alert hub 104 can identify the alert within the data received from the monitored systems 114. By not having to wait to perform correlation searches using the ingested data to detect an alert, the alert hub 104 eliminates correlation searches, and instead uses in-stream enrichment to generate near real-time alerts. This can significantly reduce the total time from ingesting the data to detecting an alert (e.g., from 5-15 minutes to about 1 minute). Further, instead of having to access different systems, users can use a same system to receive real-time alerts and determine a root cause of the alert using the analytics provided by the data platform.

In some examples, the alert hub 104 routes/transmits an alert object 108 to an alert destination 170 based on information included within the received data from the monitored systems 114. According to some configurations, an alert object 108 can be modified at an alert destination 170 prior to delivery to an end user. The modified alert object can then be provided to a user. Once the alert object 108 is delivered (or at some other specified time), the alert hub 104 in some examples marks the alert as consumed. In some examples, once the alert object 108 is marked as consumed, the alert object 108 is prevented from being modified. A search, however, can be used to locate an alert within the ingested data. After some period, the alert object 108 can be deleted or archived. In some examples, the alert can cause an automated process to be performed (e.g., cause a playbook to be activated, restart a system, change a parameter, and the like).

In some configurations, the correlation and analysis system 165 correlates an alert object 108 with the associated data ingested by the data platform and/or other data related to the alert (e.g., historical data). According to some examples, the alert object 108 is correlated with traces and/or log data ingested by the logs data ingest system 115 and the observability data ingest system 155 of the data platform 102. For instance, when the ingested data associated with an alert object 108 becomes available within the data platform 102, the correlation and analysis system 165 of the data platform 102, or some other component/device, correlates the alert object 108 with the ingested data (e.g., log data and/or trace data) and/or other data that is related to the alert object (e.g., the data can be used to determine analytics associated with a cause of the alert). According to some configurations, the correlation and analysis system 165, the observability analysis system 160, and/or the logs data analysis system 120 of the data platform 102 analyzes the ingested data to assist in identifying a root cause for the alert.

In some examples, the correlation and analysis system 165 provides data related to the alert to the observability system 150 for display within a user interface, such as a dashboard that is presented for display on a user device. For example, in response to a user selecting a link (e.g., within the alert object), a dashboard can be presented that displays information relating to the alert object and when available, correlated data that has been ingested and made available by the observability analysis system 160, and/or the logs data analysis system 120. In some examples, the correlation and analysis system 165 can update the dashboard when additional data is ingested by the data platform 102. For example, the correlation and analysis system 165 may generate additional correlated data in response to receiving additional data from the monitored systems 114.

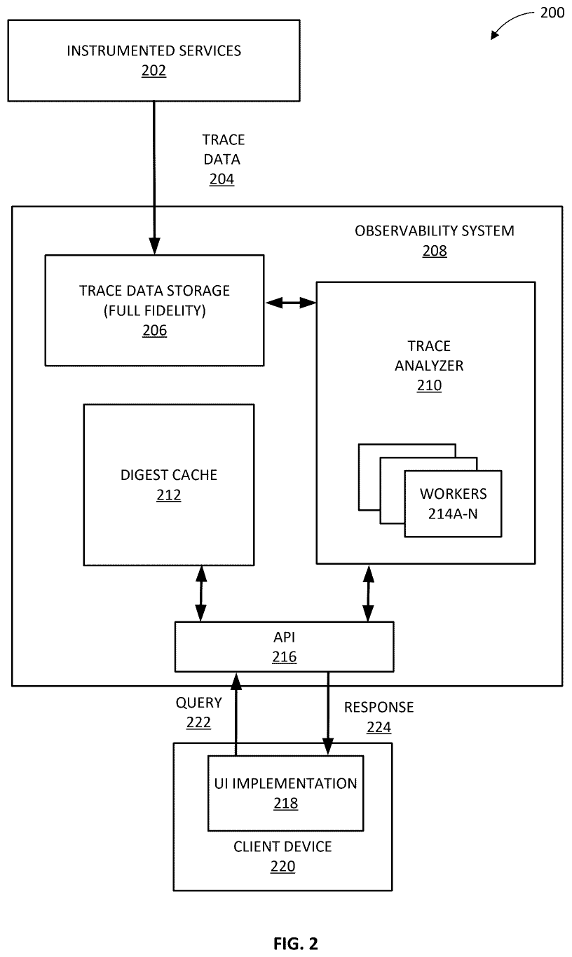

FIG. 2 illustrates a block diagram of a trace analysis environment 200, according to some examples. As shown, instrumented services 202 provide trace data 204 (also known herein as “traces”) to an observability system 208, where received trace data 204 is stored in full-fidelity trace data storage 206. The full-fidelity trace data storage 206 may include any type of data storage, including hard disk drive storage, flash memory storage, random access memory (RAM) storage, etc. Each of the instrumented services 202 may include computing hardware and/or software and may include a monitoring agent that monitors data input to and output by the instrumented service 202.

In some configurations, trace data 204 is received from one or more instrumented services 202, and the received trace data are stored. In some examples, each of the instrumented services 202 may include a monitoring agent that monitors data input to and output by the instrumented service. For example, the instrumented service 202 may include one or more hardware and/or software components. In another example, the monitoring agent may include software that is installed within the service (e.g., that “instrument” the service).

Additionally, in some examples, the trace data 204 (also known herein as “traces”) may be sent from the monitoring agents of the instrumented services 202 to an analysis system (such as the observability system 150 of FIG. 1, the observability system 208 of FIG. 2, etc.). For example, the trace data 204 may be stored in a full-fidelity trace storage location within the analysis system (such as the trace data storage 206 of FIG. 2, etc.). In some examples, each instance of trace data may include details of a transaction that propagates from one service to another within a computing environment.

Further, in some examples, this transaction may include an end-to-end request-response flow, starting with the sending of an initial request and ending with the receipt of a final response to such request. In some examples, each instance of trace data may follow a course of a transaction from its source to its ultimate destination in a computing environment. In some examples, each instance of trace data may be conceptualized as a highly dimensional structured log that captures a full graph of user-generated and background request execution and which contains information about interactions as well as causality.

Further still, in some examples, each instance of trace data may include a plurality of spans, where each span may indicate an individual unit of work performed during a particular transaction. In some examples, each span may be provided with associated tags. For example, these tags may include data such as a unique span identifier (ID), a service name, an operation name, a duration (e.g., a latency between the sending of a query to a database and the receipt of a response from the database), start and end timestamps, a location/region, and the like.

Additionally, within the trace analysis environment 200, a user interface (UI) implementation 218 of a client device 220 is in communication with an application program interface (API) service 216 of the observability system 208. In some examples, the client device 220 may include computing hardware and/or software that enables the UI implementation 218. The UI implementation 218 may include an interface used by one or more users to submit queries 222 to the observability system 108 and view a response 224 to the query 322. In other examples, the UI implementation 218 may include an interface used by one or more users to view correlated data associated with one or more alert objects and/or analysis data associated with one or more causes/root cause of an alert object.

According to some configurations, the group of workers 214A-N may incrementally return (to the API service 216) updated data and sampled example traces as they become available after ingestion and indexing. In addition, the UI implementation 218 may periodically poll the API service 216 for updates to the query 122 and/or updated data, and each time a polling request is received, the API service 216 may retrieve and return the latest data from the digest cache 212.

In some environments, a user of the observability system 208 may install and configure, on computing devices owned and operated by the user, one or more software applications that implement some or all of the components of the observability system 208. For example, with reference to FIG. 2, a user may install a software application on the instrumented services 202 owned by the user and configure each server to operate as one or more components of the observability system 208. This arrangement generally may be referred to as an “on-premises” solution. That is, the observability system 208 can be installed and can operate on computing devices directly controlled by the user of observability system 208. Some users may prefer an on-premises solution because it may provide a greater level of control over the configuration of certain aspects of the system (e.g., security, privacy, standards, controls, etc.). However, other users may instead prefer an arrangement in which the user is not directly responsible for providing and managing the computing devices upon which various components of the observability system 108 operate.

In certain implementations, one or more of the components of the observability system 208 can be implemented in a shared computing resource environment. In this context, a shared computing resource environment or cloud-based service can refer to a service hosted by one more computing resources that are accessible to end users over a network, for example, by using a web browser or other application on a client device to interface with the remote computing resources. For example, a service provider may provide an observability system 208 by managing computing resources configured to implement various aspects of the system (e.g., the trace analyzer 210, the API service 216, the digest cache 212, the full fidelity trace data storage 306, other components, etc.) and by providing access to the system to end users via a network. Typically, a user may pay a subscription or other fee to use such a service. Each subscribing user of the cloud-based service may be provided with an account that enables the user to configure a customized cloud-based system based on the user's preferences.

When implemented in a shared computing resource environment, the underlying hardware (non-limiting examples: processors, hard drives, solid-state memory, RAM, etc.) on which the components of the observability system 208 execute can be shared by multiple customers or tenants as part of the shared computing resource environment. In addition, when implemented in a shared computing resource environment as a cloud-based service, various components of the observability system 208 can be implemented using containerization or operating-system-level virtualization, or other virtualization techniques. For example, one or more components of the trace analyzer 210, the API service 216, the digest cache 212, the full fidelity trace data storage 206, etc. can be implemented as separate software containers or container instances.

Each container instance can have certain computing resources (e.g., memory, processor, etc.) of an underlying hosting computing system (e.g., server, microprocessor, etc.) assigned to it, but may share the same operating system and may use the operating system's system call interface. Each container may provide an isolated execution environment on the host system, such as by providing a memory space of the hosting system that is logically isolated from memory space of other containers. Further, each container may run the same or different computer applications concurrently or separately and may interact with each other. Although reference is made herein to containerization and container instances, it will be understood that other virtualization techniques can be used. For example, the components can be implemented using virtual machines using full virtualization or paravirtualization, etc. Thus, where reference is made to “containerized” components, it should be understood that such components may additionally or alternatively be implemented in other isolated execution environments, such as a virtual machine environment.

Implementing the observability system 208 in a shared computing resource environment can provide a number of benefits. In some cases, implementing the observability system 208 in a shared computing resource environment can make it easier to install, maintain, and update the components of the observability system 208. For example, rather than accessing designated hardware at a particular location to install or provide a component of the observability system 208, a component can be remotely instantiated or updated as desired. Similarly, implementing the observability system 208 in a shared computing resource environment or as a cloud-based service can make it easier to meet dynamic demand. For example, if the observability system 208 experiences significant load at indexing or search, additional compute resources can be deployed to process the additional data or queries. In an “on-premises” environment, this type of flexibility and scalability may not be possible or feasible.

In addition, by implementing the observability system 208 in a shared computing resource environment or as a cloud-based service can improve compute resource utilization. For example, in an on-premises environment if the designated compute resources are not being used by, they may sit idle and unused. In a shared computing resource environment, if the compute resources for a particular component are not being used, they can be re-allocated to other tasks within the observability system 208 and/or to other systems unrelated to the observability system 108.

As mentioned, in an on-premises environment, data from one instance of an observability system 208 is logically and physically separated from the data of another instance of an observability system 208 by virtue of each instance having its own designated hardware. As such, data from different customers of the observability system 208 is logically and physically separated from each other. In a shared computing resource environment, components of an observability system 208 can be configured to process the data from one customer or tenant or from multiple customers or tenants. Even in cases where a separate component of an observability system 208 is used for each customer, the underlying hardware on which the components of the observability system 208 are instantiated may still process data from different tenants. Accordingly, in a shared computing resource environment, the data from different tenants may not be physically separated on distinct hardware devices. For example, data from one tenant may reside on the same hard drive as data from another tenant or be processed by the same processor. In such cases, the observability system 208 can maintain logical separation between tenant data. For example, the observability system 208 can include separate directories for different tenants and apply different permissions and access controls to access the different directories or to process the data, etc.

In certain cases, the tenant data from different tenants is mutually exclusive and/or independent from each other. For example, in certain cases, Tenant A and Tenant B do not share the same data, similar to the way in which data from a local hard drive of Customer A is mutually exclusive and independent of the data (and not considered part) of a local hard drive of Customer B. While Tenant A and Tenant B may have matching or identical data, each tenant would have a separate copy of the data. For example, with reference again to the local hard drive of Customer A and Customer B example, each hard drive could include the same file. However, each instance of the file would be considered part of the separate hard drive and would be independent of the other file. Thus, one copy of the file would be part of Customer A's hard drive and a separate copy of the file would be part of Customer B's hard drive. In a similar manner, to the extent Tenant A has a file that is identical to a file of Tenant B, each tenant would have a distinct and independent copy of the file stored in different locations on a data store or on different data stores.

Further, in certain cases, the observability system 208 can maintain the mutual exclusivity and/or independence between tenant data even as the tenant data is being processed, stored, and searched by the same underlying hardware. In certain cases, to maintain the mutual exclusivity and/or independence between the data of different tenants, the observability system 108 can use tenant identifiers to uniquely identify data associated with different tenants.

In a shared computing resource environment, some components of the observability system 208 can be instantiated and designated for individual tenants and other components can be shared by multiple tenants. In certain implementations, the trace analyzer 210, the API service 216, the digest cache 212, the full fidelity trace data storage 206, etc. can be instantiated for each tenant or shared by multiple tenants. In some such implementations where components are shared by multiple tenants, the components can maintain separate directories for the different tenants to ensure their mutual exclusivity and/or independence from each other. Similarly, in some such implementations, the observability system 208 can use different hosting computing systems or different isolated execution environments to process the data from the different tenants as part of the trace analyzer 210, the API service 216, the digest cache 212, the full fidelity trace data storage 206, etc.

In some implementations, individual components of the trace analyzer 210, the API service 216, the digest cache 212, the full fidelity trace data storage 206, etc. may be instantiated for each tenant or shared by multiple tenants. For example, some individual intake system components (e.g., forwarders, output ingestion buffer) may be instantiated and designated for individual tenants, while other intake system components (e.g., a data retrieval system, intake ingestion buffer, and/or streaming data processor), may be shared by multiple tenants.

In some cases, by sharing more components with different tenants, the functioning of the observability system 208 can be improved. For example, by sharing components across tenants, the observability system 208 can improve resource utilization, thereby reducing an amount of resources allocated as a whole.

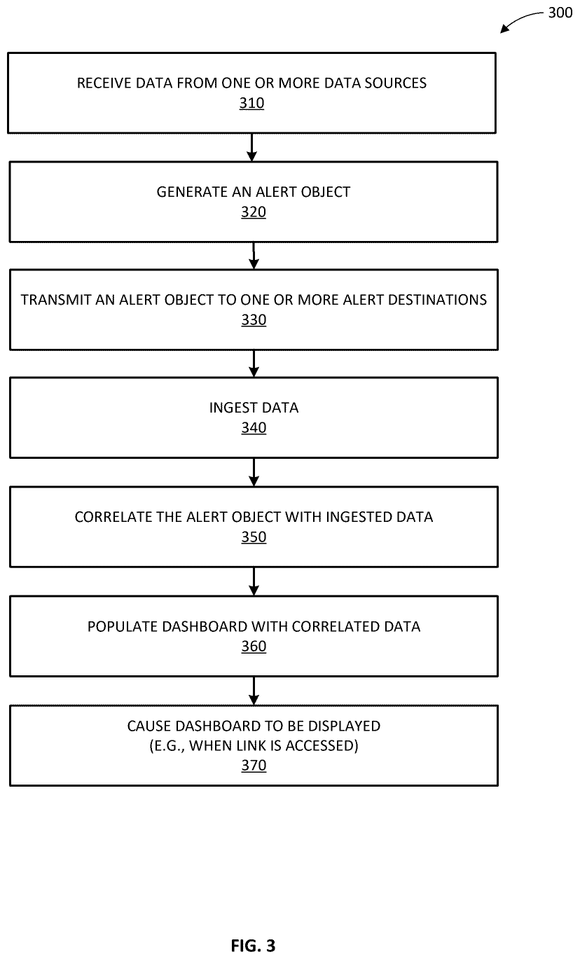

FIG. 3 is a flowchart illustrating an example process 300 for real-time alerting and correlating ingested data, in accordance with at least one implementation. The example process 300 can be implemented, for example, by a computing device that comprises a processor and a non-transitory computer-readable medium. The non-transitory computer readable medium can be storing instructions that, when executed by the processor, can cause the processor to perform the operations of the illustrated process 300. Alternatively, or additionally, the process 300 can be implemented using a non-transitory computer-readable medium storing instructions that, when executed by one or more processors, case the one or more processors to perform the operations of the process 300 of FIG. 3.

At 310, data is received from one or more data sources. As discussed above, the alert hub system 104, the log analysis system 110, and the observability system 150 can receive data from different monitored systems 114, the same monitored systems 114, or a combination of both. For example, the data platform 102 can receive raw or pre-processed telemetry data from the monitored systems 114, including metrics, logs, traces, and/or other types of data.

At 320, an alert object is generated. As discussed above, after detecting/determining an alert, the alert hub 104 generates the alert object 108. In some configurations, the alert hub 104 generates an alert object 108 that can include fields such as but not limited to an identifier (e.g., a globally unique identifier (GUID)), information identifying a source of the alert, information identifying one or more alert destinations 170 to transmit an alert, a status of the alert, time information related to the alert, as well an option to provide additional information along with an alert. According to some configurations, the alert hub 104 automatically tags the alert object 108 with system and other information relating to the alert.

At 330, an alert object is transmitted to one or more alert destinations 170. As discussed above, the alert hub 104 transmits the alert object 108 to one or more alert destinations 170. In some cases, the alert object 108 may be modified before delivery to an end user. For instance, the alert object 108 may be modified by one or more components that receive the alert object 108, such as but not limited to performing operations (e.g., add modifiers, add application specific data, different applications can interact with the same alert object, add a field, perform some operation, . . . ).

At 340, data is ingested by a data platform. As discussed above, the data platform 102 ingests the data received from the monitored systems 114 such that the data ingested by the logs analysis system 110, the observability system 150, and/or other data can be correlated with the alert object 108 and/or be used by the correlation and analysis system 165 for analysis.

At 350, the alert object is correlated with the related ingested data. As discussed above, the correlation and analysis system 165 correlates an alert object 108 with the associated data ingested by the data platform and/or other data related to the alert (e.g., historical data). According to some examples, the alert object 108 is correlated with traces and/or log data ingested by the logs data ingest system 115 and the observability data ingest system 155 of the data platform 102. For instance, when the ingested data associated with an alert object 108 becomes available within the data platform 102, the correlation and analysis system 165 of the data platform 102, or some other component/device, correlates the alert object 108 with the ingested data (e.g., log data and/or trace data) and/or other data that is related to the alert object (e.g., the data can be used to determine analytics associated with a cause of the alert).

At 360, a dashboard is populated with correlated data. As discussed above, the correlation and analysis system 165 provides data related to the alert to the observability system 150 for display within a user interface, such as a dashboard that is presented for display on a user device. For example, in response to a user selecting a link (e.g., within the alert object), a dashboard can be presented that displays information relating to the alert object and when available, correlated data that has been ingested and made available by the observability analysis system 160, and/or the logs data analysis system 120. In some examples, the correlation and analysis system 165 can update the dashboard when additional data is ingested by the data platform 102. For example, the correlation and analysis system 165 may generate additional correlated data in response to receiving additional data from the monitored systems 114

At 370, the dashboard is caused to be displayed. As discussed above, the data platform 102 can cause a user interface, such as the dashboard to be displayed.

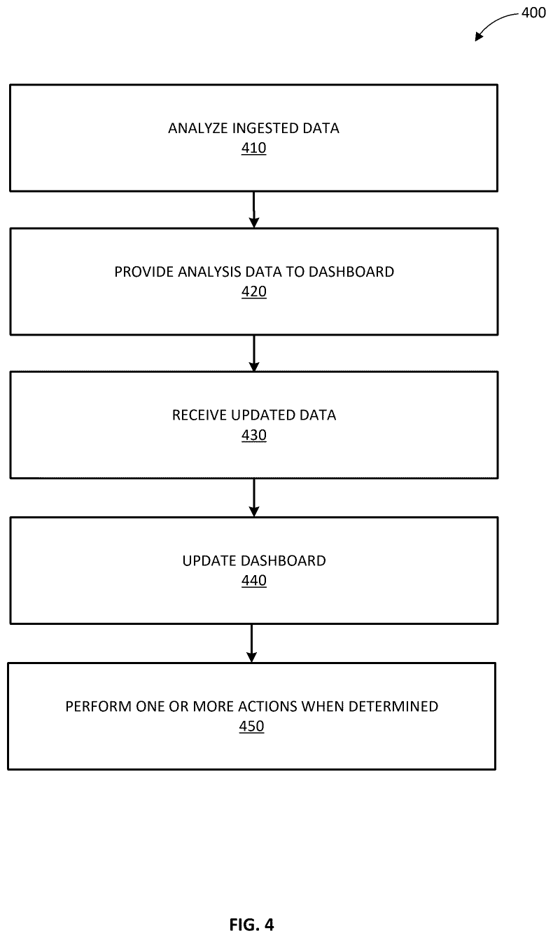

FIG. 4 is a flowchart illustrating an example process for updating a dashboard, according to at least one implementation. The example process 400 can be implemented, for example, by a computing device that comprises a processor and a non-transitory computer-readable medium. The non-transitory computer readable medium can be storing instructions that, when executed by the processor, can cause the processor to perform the operations of the illustrated process 400. Alternatively, or additionally, the process 400 can be implemented using a non-transitory computer-readable medium storing instructions that, when executed by one or more processors, case the one or more processors to perform the operations of the process 400 of FIG. 4.

At 410, the ingested data is analyzed. As discussed above, according to some configurations, the correlation and analysis system 165, the observability analysis system 160, and/or the logs data analysis system 120 of the data platform 102 analyzes the ingested data to assist in identifying one or more causes and/or a root cause for the alert object 108.

At 420, analysis data is provided to the dashboard. As discussed above, the correlation and analysis system 165 provides data related to the alert to the observability system 150 for display within a user interface, such as a dashboard that is presented for display on a user device.

At 430, updated analysis data is received. As discussed above, the correlation and analysis system 165 may determine that additional data ingested by the data platform 102 and/or data generated that relates to the alert can be provided to the observability system 150 for an updated display within the dashboard.

At 440, the dashboard is updated with the updated analysis data. As discussed above, the data platform 102 can update the dashboard as soon as additional correlated data is determined.

At 450, one or more actions can be performed when determined. For example, in response to receiving an alert object 108 a component may cause a playbook, or some other operation to be performed.

Entities of various types, such as companies, educational institutions, medical facilities, governmental departments, and private individuals, among other examples, operate computing environments for various purposes. Computing environments, which can also be referred to as information technology environments, can include inter-networked, physical hardware devices, the software executing on the hardware devices, and the users of the hardware and software. As an example, an entity such as a school can operate a Local Area Network (LAN) that includes desktop computers, laptop computers, smart phones, and tablets connected to a physical and wireless network, where users correspond to teachers and students. In this example, the physical devices may be in buildings or a campus that is controlled by the school. As another example, an entity such as a business can operate a Wide Area Network (WAN) that includes physical devices in multiple geographic locations where the offices of the business are located. In this example, the different offices can be inter-networked using a combination of public networks such as the Internet and private networks. As another example, an entity can operate a data center at a centralized location, where computing resources (such as compute, memory, and/or networking resources) are kept and maintained, and whose resources are accessible over a network to users who may be in different geographical locations. In this example, users associated with the entity that operates the data center can access the computing resources in the data center over public and/or private networks that may not be operated and controlled by the same entity. Alternatively, or additionally, the operator of the data center may provide the computing resources to users associated with other entities, for example on a subscription basis. Such a data center operator may be referred to as a cloud services provider, and the services provided by such an entity may be described by one or more service models, such as to Software-as-a Service (SaaS) model, Infrastructure-as-a-Service (IaaS) model, or Platform-as-a-Service (PaaS), among others. In these examples, users may expect resources and/or services to be available on demand and without direct active management by the user, a resource delivery model often referred to as cloud computing.

Entities that operate computing environments need information about their computing environments. For example, an entity may need to know the operating status of the various computing resources in the entity's computing environment, so that the entity can administer the environment, including performing configuration and maintenance, performing repairs or replacements, provisioning additional resources, removing unused resources, or addressing issues that may arise during operation of the computing environment, among other examples. As another example, an entity can use information about a computing environment to identify and remediate security issues that may endanger the data, users, and/or equipment in the computing environment. As another example, an entity may be operating a computing environment for some purpose (e.g., to run an online store, to operate a bank, to manage a municipal railway, etc.) and may want information about the computing environment that can aid the entity in understanding whether the computing environment is operating efficiently and for its intended purpose.

Entities that operate computing environments need information about their computing environments. For example, an entity may need to know the operating status of the various computing resources in the entity's computing environment, so that the entity can administer the environment, including performing configuration and maintenance, performing repairs or replacements, provisioning additional resources, removing unused resources, or addressing issues that may arise during operation of the computing environment, among other examples. As another example, an entity can use information about a computing environment to identify and remediate security issues that may endanger the data, users, and/or equipment in the computing environment. As another example, an entity may be operating a computing environment for some purpose (e.g., to run an online store, to operate a bank, to manage a municipal railway, etc.) and may want information about the computing environment that can aid the entity in understanding whether the computing environment is operating efficiently and for its intended purpose.

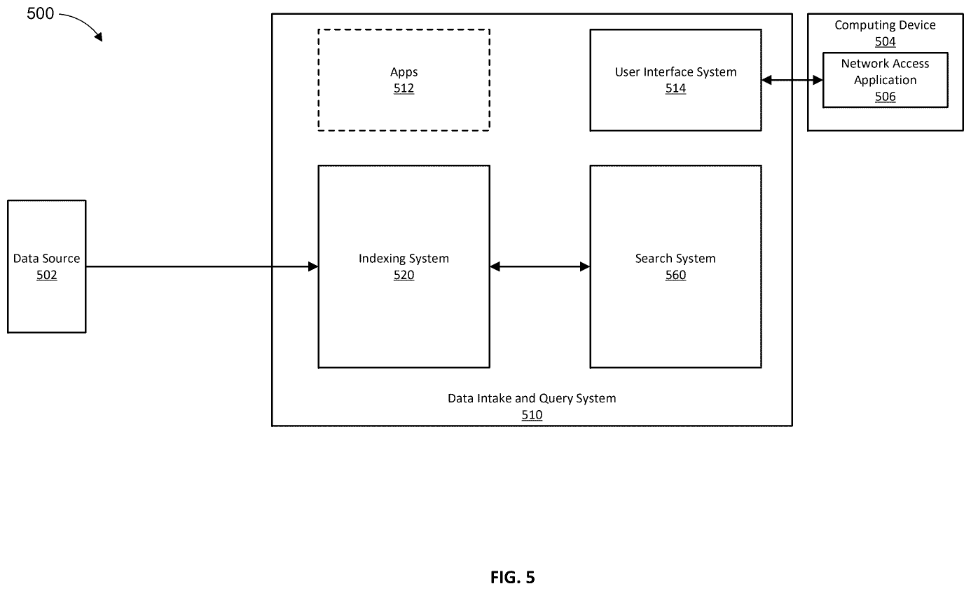

Collection and analysis of the data from a computing environment can be performed by a data intake and query system such as is described herein. A data intake and query system can ingest, and store data obtained from the components in a computing environment, and can enable an entity to search, analyze, and visualize the data. Through these and other capabilities, the data intake and query system can enable an entity to use the data for administration of the computing environment, to detect security issues, to understand how the computing environment is performing or being used, and/or to perform other analytics. FIG. 5 is a block diagram illustrating an example computing environment 500 that includes a data intake and query system 510. The data intake and query system 510 obtains data from a data source 502 in the computing environment 500 and ingests the data using an indexing system 520. A search system 560 of the data intake and query system 510 enables users to navigate the indexed data. Though drawn with separate boxes in FIG. 5, in some implementations the indexing system 520 and the search system 560 can have overlapping components. A computing device 504, running a network access application 506, can communicate with the data intake and query system 510 through a user interface system 514 of the data intake and query system 510. Using the computing device 504, a user can perform various operations with respect to the data intake and query system 510, such as administration of the data intake and query system 510, management and generation of “knowledge objects,” (user-defined entities for enriching data, such as saved searches, event types, tags, field extractions, lookups, reports, alerts, data models, workflow actions, and fields), initiating of searches, and generation of reports, among other operations. The data intake and query system 510 can further optionally include apps 512 that extend the search, analytics, and/or visualization capabilities of the data intake and query system 510.

The data intake and query system 510 can be implemented using program code that can be executed using a computing device. A computing device is an electronic device that has a memory for storing program code instructions and a hardware processor for executing the instructions. The computing device can further include other physical components, such as a network interface or components for input and output. The program code for the data intake and query system 510 can be stored on a non-transitory computer-readable medium, such as a magnetic or optical storage disk or a flash or solid-state memory, from which the program code can be loaded into the memory of the computing device for execution. “Non-transitory” means that the computer-readable medium can retain the program code while not under power, as opposed to volatile or “transitory” memory or media that requires power in order to retain data.

In various examples, the program code for the data intake and query system 510 can be executed on a single computing device, or execution of the program code can be distributed over multiple computing devices. For example, the program code can include instructions for both indexing and search components (which may be part of the indexing system 520 and/or the search system 560, respectively), which can be executed on a computing device that also provides the data source 502. As another example, the program code can be executed on one computing device, where execution of the program code provides both indexing and search components, while another copy of the program code executes on a second computing device that provides the data source 502. As another example, the program code can be configured such that, when executed, the program code implements only an indexing component or only a search component. In this example, a first instance of the program code that is executing the indexing component and a second instance of the program code that is executing the search component can be executing on the same computing device or on different computing devices.

The data source 502 of the computing environment 500 is a component of a computing device that produces machine data. The component can be a hardware component (e.g., a microprocessor or a network adapter, among other examples) or a software component (e.g., a part of the operating system or an application, among other examples). The component can be a virtual component, such as a virtual machine, a virtual machine monitor (also referred as a hypervisor), a container, or a container orchestrator, among other examples. Examples of computing devices that can provide the data source 502 include personal computers (e.g., laptops, desktop computers, etc.), handheld devices (e.g., smart phones, tablet computers, etc.), servers (e.g., network servers, compute servers, storage servers, domain name servers, web servers, etc.), network infrastructure devices (e.g., routers, switches, firewalls, etc.), and “Internet of Things” devices (e.g., vehicles, home appliances, factory equipment, etc.), among other examples. Machine data is electronically generated data that is output by the component of the computing device and reflects activity of the component. Such activity can include, for example, operation status, actions performed, performance metrics, communications with other components, or communications with users, among other examples. The component can produce machine data in an automated fashion (e.g., through the ordinary course of being powered on and/or executing) and/or as a result of user interaction with the computing device (e.g., through the user's use of input/output devices or applications). The machine data can be structured, semi-structured, and/or unstructured. The machine data may be referred to as raw machine data when the data is unaltered from the format in which the data was output by the component of the computing device. Examples of machine data include operating system logs, web server logs, live application logs, network feeds, metrics, change monitoring, message queues, and archive files, among other examples.

As discussed in greater detail below, the indexing system 520 obtains machine date from the data source 502 and processes and stores the data. Processing and storing of data may be referred to as “ingestion” of the data. Processing of the data can include parsing the data to identify individual events, where an event is a discrete portion of machine data that can be associated with a timestamp. Processing of the data can further include generating an index of the events, where the index is a data storage structure in which the events are stored. The indexing system 520 does not require prior knowledge of the structure of incoming data (e.g., the indexing system 520 does not need to be provided with a schema describing the data). Additionally, the indexing system 520 retains a copy of the data as it was received by the indexing system 520 such that the original data is always available for searching (e.g., no data is discarded, though, in some examples, the indexing system 520 can be configured to do so).

The search system 560 searches the data stored by the indexing 520 system. As discussed in greater detail below, the search system 560 enables users associated with the computing environment 500 (and possibly also other users) to navigate the data, generate reports, and visualize search results in “dashboards” output using a graphical interface. Using the facilities of the search system 560, users can obtain insights about the data, such as retrieving events from an index, calculating metrics, searching for specific conditions within a rolling time window, identifying patterns in the data, and predicting future trends, among other examples. To achieve greater efficiency, the search system 560 can apply map-reduce methods to parallelize searching of large volumes of data. Additionally, because the original data is available, the search system 560 can apply a schema to the data at search time. This allows different structures to be applied to the same data, or for the structure to be modified if or when the content of the data changes. Application of a schema at search time may be referred to herein as a late-binding schema technique.

The user interface system 514 provides mechanisms through which users associated with the computing environment 500 (and possibly others) can interact with the data intake and query system 510. These interactions can include configuration, administration, and management of the indexing system 520, initiation and/or scheduling of queries that are to be processed by the search system 560, receipt or reporting of search results, and/or visualization of search results. The user interface system 514 can include, for example, facilities to provide a command line interface or a web-based interface.

Users can access the user interface system 514 using a computing device 504 that communicates with data intake and query system 510, possibly over a network. A “user,” in the context of the implementations and examples described herein, is a digital entity that is described by a set of information in a computing environment. The set of information can include, for example, a user identifier, a username, a password, a user account, a set of authentication credentials, a token, other data, and/or a combination of the preceding. Using the digital entity that is represented by a user, a person can interact with the computing environment 500. For example, a person can log in as a particular user and, using the user's digital information, can access the data intake and query system 510. A user can be associated with one or more people, meaning that one or more people may be able to use the same user's digital information. For example, an administrative user account may be used by multiple people who have been given access to the administrative user account. Alternatively or additionally, a user can be associated with another digital entity, such as a bot (e.g., a software program that can perform autonomous tasks). A user can also be associated with one or more entities. For example, a company can have associated with it a number of users. In this example, the company may control the users'digital information, including assignment of user identifiers, management of security credentials, control of which persons are associated with which users, and so on.

The computing device 504 can provide a human-machine interface through which a person can have a digital presence in the computing environment 500 in the form of a user. The computing device 504 is an electronic device having one or more processors and a memory capable of storing instructions for execution by the one or more processors. The computing device 504 can further include input/output (I/O) hardware and a network interface. Applications executed by the computing device 504 can include a network access application 506, such as a web browser, which can use a network interface of the client computing device 504 to communicate, over a network, with the user interface system 514 of the data intake and query system #A110. The user interface system 514 can use the network access application 506 to generate user interfaces that enable a user to interact with the data intake and query system #A110. A web browser is one example of a network access application. A shell tool can also be used as a network access application. In some examples, the data intake and query system 510 is an application executing on the computing device 506. In such examples, the network access application 506 can access the user interface system 514 without going over a network.

The data intake and query system 510 can optionally include apps 512. An app of the data intake and query system 510 is a collection of configurations, knowledge objects (a user-defined entity that enriches the data in the data intake and query system 510), views, and dashboards that may provide additional functionality, different techniques for searching the data, and/or additional insights into the data. The data intake and query system 510 can execute multiple applications simultaneously. Example applications include an information technology service intelligence application, which can monitor and analyze the performance and behavior of the computing environment 500, and an enterprise security application, which can include content and searches to assist security analysts in diagnosing and acting on anomalous or malicious behavior in the computing environment 500.

Though FIG. 5 illustrates only one data source, in practical implementations, the computing environment 500 contains many data sources spread across numerous computing devices. The computing devices may be controlled and operated by a single entity. For example, in an “on the premises” or “on-prem” implementation, the computing devices may physically and digitally be controlled by one entity, meaning that the computing devices are in physical locations that are owned and/or operated by the entity and are within a network domain that is controlled by the entity. In an entirely on-prem implementation of the computing environment 500, the data intake and query system 510 executes on an on-prem computing device and obtains machine data from on-prem data sources. An on-prem implementation can also be referred to as an “enterprise” network, though the term “on-prem” refers primarily to physical locality of a network and who controls that location while the term “enterprise” may be used to refer to the network of a single entity. As such, an enterprise network could include cloud components.

“Cloud” or “in the cloud” refers to a network model in which an entity operates network resources (e.g., processor capacity, network capacity, storage capacity, etc.), located for example in a data center, and makes those resources available to users and/or other entities over a network. A “private cloud” is a cloud implementation where the entity provides the network resources only to its own users. A “public cloud” is a cloud implementation where an entity operates network resources in order to provide them to users that are not associated with the entity and/or to other entities. In this implementation, the provider entity can, for example, allow a subscriber entity to pay for a subscription that enables users associated with subscriber entity to access a certain amount of the provider entity's cloud resources, possibly for a limited time. A subscriber entity of cloud resources can also be referred to as a tenant of the provider entity. Users associated with the subscriber entity access the cloud resources over a network, which may include the public Internet. In contrast to an on-prem implementation, a subscriber entity does not have physical control of the computing devices that are in the cloud, and has digital access to resources provided by the computing devices only to the extent that such access is enabled by the provider entity.

In some implementations, the computing environment 500 can include on-prem and cloud-based computing resources, or only cloud-based resources. For example, an entity may have on-prem computing devices and a private cloud. In this example, the entity operates the data intake and query system 510 and can choose to execute the data intake and query system 510 on an on-prem computing device or in the cloud. In another example, a provider entity operates the data intake and query system 510 in a public cloud and provides the functionality of the data intake and query system 510 as a service, for example under a Software-as-a-Service (SaaS) model, to entities that pay for the user of the service on a subscription basis. In this example, the provider entity can provision a separate tenant (or possibly multiple tenants) in the public cloud network for each subscriber entity, where each tenant executes a separate and distinct instance of the data intake and query system 510. In some implementations, the entity providing the data intake and query system 510 is itself subscribing to the cloud services of a cloud service provider. As an example, a first entity provides computing resources under a public cloud service model, a second entity subscribes to the cloud services of the first provider entity and uses the cloud computing resources to operate the data intake and query system 510, and a third entity can subscribe to the services of the second provider entity in order to use the functionality of the data intake and query system 510. In this example, the data sources are associated with the third entity, users accessing the data intake and query system 510 are associated with the third entity, and the analytics and insights provided by the data intake and query system 510 are for purposes of the third entity's operations.

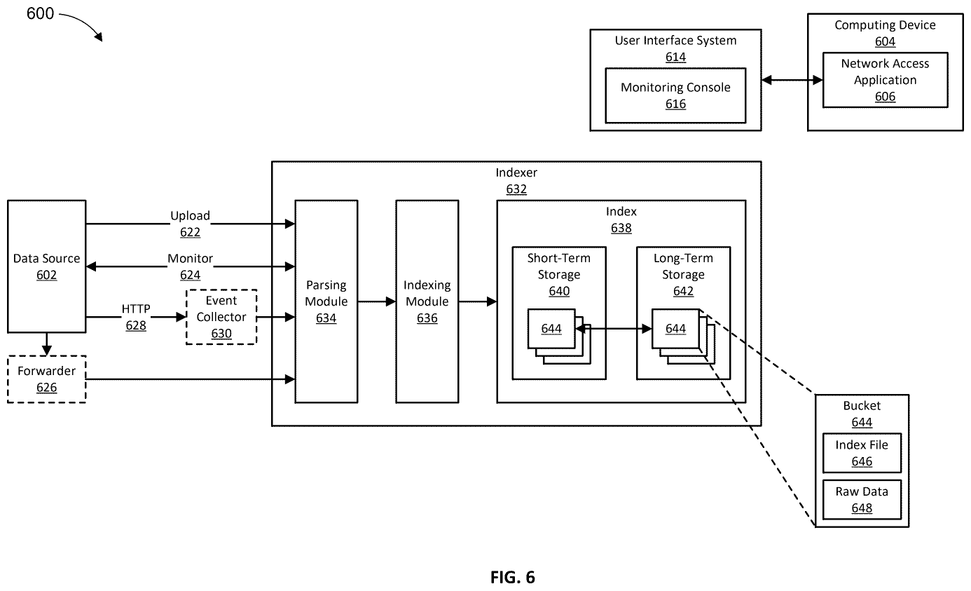

FIG. 6 is a block diagram illustrating in greater detail an example of an indexing system 620 of a data intake and query system, such as the data intake and query system 510 of FIG. 5. The indexing system 620 of FIG. 6 uses various methods to obtain machine data from a data source 602 and stores the data in an index 638 of an indexer 632. As discussed previously, a data source is a hardware, software, physical, and/or virtual component of a computing device that produces machine data in an automated fashion and/or as a result of user interaction. Examples of data sources include files and directories; network event logs; operating system logs, operational data, and performance monitoring data; metrics; first-in, first-out queues; scripted inputs; and modular inputs, among others. The indexing system 620 enables the data intake and query system to obtain the machine data produced by the data source 602 and to store the data for searching and retrieval.

Users can administer the operations of the indexing system 620 using a computing device 604 that can access the indexing system 620 through a user interface system 614 of the data intake and query system. For example, the computing device 604 can be executing a network access application 606, such as a web browser or a terminal, through which a user can access a monitoring console 616 provided by the user interface system 614. The monitoring console 616 can enable operations such as: identifying the data source 602 for data ingestion; configuring the indexer 632 to index the data from the data source 632; configuring a data ingestion method; configuring, deploying, and managing clusters of indexers; and viewing the topology and performance of a deployment of the data intake and query system, among other operations. The operations performed by the indexing system 620 may be referred to as “index time” operations, which are distinct from “search time” operations that are discussed further below.

The indexer 632, which may be referred to herein as a data indexing component, coordinates and performs most of the index time operations. The indexer 632 can be implemented using program code that can be executed on a computing device. The program code for the indexer 632 can be stored on a non-transitory computer-readable medium (e.g. a magnetic, optical, or solid state storage disk, a flash memory, or another type of non-transitory storage media), and from this medium can be loaded or copied to the memory of the computing device. One or more hardware processors of the computing device can read the program code from the memory and execute the program code in order to implement the operations of the indexer 632. In some implementations, the indexer 632 executes on the computing device 604 through which a user can access the indexing system 620. In some implementations, the indexer 632 executes on a different computing device than the illustrated computing device 604.

The indexer 632 may be executing on the computing device that also provides the data source 602 or may be executing on a different computing device. In implementations wherein the indexer 632 is on the same computing device as the data source 602, the data produced by the data source 602 may be referred to as “local data.” In other implementations the data source 602 is a component of a first computing device and the indexer 632 executes on a second computing device that is different from the first computing device. In these implementations, the data produced by the data source 602 may be referred to as “remote data.” In some implementations, the first computing device is “on-prem” and in some implementations the first computing device is “in the cloud.” In some implementations, the indexer 632 executes on a computing device in the cloud and the operations of the indexer 632 are provided as a service to entities that subscribe to the services provided by the data intake and query system.

For a given data produced by the data source 602, the indexing system 620 can be configured to use one of several methods to ingest the data into the indexer 632. These methods include upload 622, monitor 624, using a forwarder 626, or using HyperText Transfer Protocol (HTTP 628) and an event collector 630. These and other methods for data ingestion may be referred to as “getting data in” (GDI) methods.

Using the upload 622 method, a user can specify a file for uploading into the indexer 632. For example, the monitoring console 616 can include commands or an interface through which the user can specify where the file is located (e.g., on which computing device and/or in which directory of a file system) and the name of the file. The file may be located at the data source 602 or maybe on the computing device where the indexer 632 is executing. Once uploading is initiated, the indexer 632 processes the file, as discussed further below. Uploading is a manual process and occurs when instigated by a user. For automated data ingestion, the other ingestion methods are used.

The monitor 624 method enables the indexing system 602 to monitor the data source 602 and continuously or periodically obtain data produced by the data source 602 for ingestion by the indexer 632. For example, using the monitoring console 616, a user can specify a file or directory for monitoring. In this example, the indexing system 602 can execute a monitoring process that detects whenever the file or directory is modified and causes the file or directory contents to be sent to the indexer 632. As another example, a user can specify a network port for monitoring. In this example, a monitoring process can capture data received at or transmitting from the network port and cause the data to be sent to the indexer 632. In various examples, monitoring can also be configured for data sources such as operating system event logs, performance data generated by an operating system, operating system registries, operating system directory services, and other data sources.

Monitoring is available when the data source 602 is local to the indexer 632 (e.g., the data source 602 is on the computing device where the indexer 632 is executing). Other data ingestion methods, including forwarding and the event collector 630, can be used for either local or remote data sources.

A forwarder 626, which may be referred to herein as a data forwarding component, is a software process that sends data from the data source 602 to the indexer 632. The forwarder 626 can be implemented using program code that can be executed on the computer device that provides the data source 602. A user launches the program code for the forwarder 626 on the computing device that provides the data source 602. The user can further configure the forwarder 626, for example to specify a receiver for the data being forwarded (e.g., one or more indexers, another forwarder, and/or another recipient system), to enable or disable data forwarding, and to specify a file, directory, network events, operating system data, or other data to forward, among other operations.

The forwarder 626 can provide various capabilities. For example, the forwarder 626 can send the data unprocessed or can perform minimal processing on the data before sending the data to the indexer 632. Minimal processing can include, for example, adding metadata tags to the data to identify a source, source type, and/or host, among other information, dividing the data into blocks, and/or applying a timestamp to the data.. In some implementations, the forwarder 626 can break the data into individual events (event generation is discussed further below) and send the events to a receiver. Other operations that the forwarder 626 may be configured to perform include buffering data, compressing data, and using secure protocols for sending the data, for example.

Forwarders can be configured in various topologies. For example, multiple forwarders can send data to the same indexer. As another example, a forwarder can be configured to filter and/or route events to specific receivers (e.g., different indexers), and/or discard events. As another example, a forwarder can be configured to send data to another forwarder, or to a receiver that is not an indexer or a forwarder (such as, for example, a log aggregator).

The event collector 630 provides an alternate method for obtaining data from the data source 602. The event collector 630 enables data and application events to be sent to the indexer 632 using HTTP 628. The event collector 630 can be implemented using program code that can be executing on a computing device. The program code may be a component of the data intake and query system or can be a standalone component that can be executed independently of the data intake and query system and operates in cooperation with the data intake and query system.

To use the event collector 630, a user can, for example using the monitoring console 616 or a similar interface provided by the user interface system 614, enable the event collector 630 and configure an authentication token. In this context, an authentication token is a piece of digital data generated by a computing device, such as a server, that contains information to identify a particular entity, such as a user or a computing device, to the server. The token will contain identification information for the entity (e.g., an alphanumeric string that is unique to each token) and a code that authenticates the entity with the server. The token can be used, for example, by the data source 602 as an alternative method to using a username and password for authentication.

To send data to the event collector 630, the data source 602 is supplied with a token and can then send HTTP 628 requests to the event collector 630. To send HTTP 628 requests, the data source 602 can be configured to use an HTTP client and/or to use logging libraries such as those supplied by Java, JavaScript, and . NET libraries. An HTTP client enables the data source 602 to send data to the event collector 630 by supplying the data, and a Uniform Resource Identifier (URI) for the event collector 630 to the HTTP client. The HTTP client then handles establishing a connection with the event collector 630, transmitting a request containing the data, closing the connection, and receiving an acknowledgment if the event collector 630 sends one. Logging libraries enable HTTP 628 requests to the event collector 630 to be generated directly by the data source. For example, an application can include or link a logging library, and through functionality provided by the logging library manage establishing a connection with the event collector 630, transmitting a request, and receiving an acknowledgement.

An HTTP 628 request to the event collector 630 can contain a token, a channel identifier, event metadata, and/or event data. The token authenticates the request with the event collector 630. The channel identifier, if available in the indexing system 620, enables the event collector 630 to segregate and keep separate data from different data sources. The event metadata can include one or more key-value pairs that describe the data source 602 or the event data included in the request. For example, the event metadata can include key-value pairs specifying a timestamp, a hostname, a source, a source type, or an index where the event data should be indexed. The event data can be a structured data object, such as a JavaScript Object Notation (JSON) object, or raw text. The structured data object can include both event data and event metadata. Additionally, one request can include event data for one or more events.

In some implementations, the event collector 630 extracts events from HTTP 628 requests and sends the events to the indexer 632. The event collector 630 can further be configured to send events to one or more indexers. Extracting the events can include associating any metadata in a request with the event or events included in the request. In these implementations, event generation by the indexer 632 (discussed further below) is bypassed, and the indexer 632 moves the events directly to indexing. In some implementations, the event collector 630 extracts event data from a request and outputs the event data to the indexer 632, and the indexer generates events from the event data. In some implementations, the event collector 630 sends an acknowledgement message to the data source 602 to indicate that the event collector 630 has received a particular request form the data source 602, and/or to indicate to the data source 602 that events in the request have been added to an index.

The indexer 632 ingests incoming data and transforms the data into searchable knowledge in the form of events. In the data intake and query system, an event is a single piece of data that represents activity of the component represented in FIG. 6 by the data source 602. An event can be, for example, a single record in a log file that records a single action performed by the component (e.g., a user login, a disk read, transmission of a network packet, etc.). An event includes one or more fields that together describe the action captured by the event, where a field is a key-value pair (also referred to as a name-value pair). In some cases, an event includes both the key and the value, and in some cases the event includes only the value and the key can be inferred or assumed.

Transformation of data into events can include event generation and event indexing. Event generation includes identifying each discrete piece of data that represents one event and associating each event with a timestamp and possibly other information (which may be referred to herein as metadata). Event indexing includes storing of each event in the data structure of an index. As an example, the indexer 632 can include a parsing module 634 and an indexing module 636 for generating and storing the events. The parsing module 634 and indexing module 636 can be modular and pipelined, such that one component can be operating on a first set of data while the second component is simultaneously operating on a second sent of data. Additionally, the indexer 632 may at any time have multiple instances of the parsing module 634 and indexing module 636, with each set of instances configured to simultaneously operate on data from the same data source or from different data sources. The parsing module 634 and indexing module 636 are illustrated in FIG. 6 to facilitate discussion, with the understanding that implementations with other components are possible to achieve the same functionality.

The parsing module 634 determines information about incoming event data, where the information can be used to identify events within the event data. For example, the parsing module 634 can associate a source type with the event data. A source type identifies the data source 602 and describes a possible data structure of event data produced by the data source 602. For example, the source type can indicate which fields to expect in events generated at the data source 602 and the keys for the values in the fields, and possibly other information such as sizes of fields, an order of the fields, a field separator, and so on. The source type of the data source 602 can be specified when the data source 602 is configured as a source of event data. Alternatively, the parsing module 634 can determine the source type from the event data, for example from an event field in the event data or using machine learning techniques applied to the event data.

Other information that the parsing module 634 can determine includes timestamps. In some cases, an event includes a timestamp as a field, and the timestamp indicates a point in time when the action represented by the event occurred or was recorded by the data source 602 as event data. In these cases, the parsing module 634 may be able to determine from the source type associated with the event data that the timestamps can be extracted from the events themselves. In some cases, an event does not include a timestamp and the parsing module 634 determines a timestamp for the event, for example from a name associated with the event data from the data source 602 (e.g., a file name when the event data is in the form of a file) or a time associated with the event data (e.g., a file modification time). As another example, when the parsing module 634 is not able to determine a timestamp from the event data, the parsing module 634 may use the time at which it is indexing the event data. As another example, the parsing module 634 can use a user-configured rule to determine the timestamps to associate with events.

The parsing module 634 can further determine event boundaries. In some cases, a single line (e.g., a sequence of characters ending with a line termination) in event data represents one event while in other cases, a single line represents multiple events. In yet other cases, one event may span multiple lines within the event data. The parsing module 634 may be able to determine event boundaries from the source type associated with the event data, for example from a data structure indicated by the source type. In some implementations, a user can configure rules the parsing module 634 can use to identify event boundaries.

The parsing module 634 can further extract data from events and possibly also perform transformations on the events. For example, the parsing module 634 can exteract a set of fields (key-value pairs) for each event, such as a host or hostname, source or source name, and/or source type. The parsing module 634 may extract certain fields by default or based on a user configuration. Alternatively, or additionally, the parsing module 634 may add fields to events, such as a source type or a user-configured field. As another example of a transformation, the parsing module 634 can anonymize fields in events to mask sensitive information, such as social security numbers or account numbers. Anonymizing fields can include changing or replacing values of specific fields. The parsing component 634 can further perform user-configured transformations.

The parsing module 634 outputs the results of processing incoming event data to the indexing module 636, which performs event segmentation and builds index data structures.

Event segmentation identifies searchable segments, which may alternatively be referred to as searchable terms or keywords, which can be used by the search system of the data intake and query system to search the event data. A searchable segment may be a part of a field in an event or an entire field. The indexer 632 can be configured to identify searchable segments that are parts of fields, searchable segments that are entire fields, or both. The parsing module 634 organizes the searchable segments into a lexicon or dictionary for the event data, with the lexicon including each searchable segment (e.g., the field “src=10.10.1.1”) and a reference to the location of each occurrence of the searchable segment within the event data (e.g., the location within the event data of each occurrence of “src=10.10.1.1”). As discussed further below, the search system can use the lexicon, which is stored in an index file 646, to find event data that matches a search query. In some implementations, segmentation can alternatively be performed by the forwarder 626. Segmentation can also be disabled, in which case the indexer 632 will not build a lexicon for the event data. When segmentation is disabled, the search system searches the event data directly.

Building index data structures generates the index 638. The index 638 is a storage data structure on a storage device (e.g., a disk drive or other physical device for storing digital data). The storage device may be a component of the computing device on which the indexer 632 is operating (referred to herein as local storage) or may be a component of a different computing device (referred to herein as remote storage) that the indexer 638 has access to over a network. The indexer 632 can manage more than one index and can manage indexes of different types. For example, the indexer 632 can manage event indexes, which impose minimal structure on stored data and can accommodate any type of data. As another example, the indexer 632 can manage metrics indexes, which use a highly structured format to handle the higher volume and lower latency demands associated with metrics data.

The indexing module 636 organizes files in the index 638 in directories referred to as buckets. The files in a bucket 644 can include raw data files, index files, and possibly also other metadata files. As used herein, “raw data” means data as when the data was produced by the data source 602, without alteration to the format or content. As noted previously, the parsing component 634 may add fields to event data and/or perform transformations on fields in the event data. Event data that has been altered in this way is referred to herein as enriched data. A raw data file 648 can include enriched data, in addition to or instead of raw data. The raw data file 648 may be compressed to reduce disk usage. An index file 646, which may also be referred to herein as a “time-series index” or tsidx file, contains metadata that the indexer 632 can use to search a corresponding raw data file 648. As noted above, the metadata in the index file 646 includes a lexicon of the event data, which associates each unique keyword in the event data with a reference to the location of event data within the raw data file 648. The keyword data in the index file 646 may also be referred to as an inverted index. In various implementations, the data intake and query system can use index files for other purposes, such as to store data summarizations that can be used to accelerate searches.

A bucket 644 includes event data for a particular range of time. The indexing module 636 arranges buckets in the index 638 according to the age of the buckets, such that buckets for more recent ranges of time are stored in short-term storage 640 and buckets for less recent ranges of time are stored in long-term storage 642. Short-term storage 640 may be faster to access while long-term storage 642 may be slower to access. Buckets may be moves from short-term storage 640 to long-term storage 642 according to a configurable data retention policy, which can indicate at what point in time a bucket is old enough to be moved.

A bucket's location in short-term storage 640 or long-term storage 642 can also be indicated by the bucket's status. As an example, a bucket's status can be “hot,” “warm,” “cold,” “frozen,” or “thawed.” In this example, hot bucket is one to which the indexer 632 is writing data and the bucket becomes a warm bucket when the index 632 stops writing data to it. In this example, both hot and warm buckets reside in short-term storage 640. Continuing this example, when a warm bucket is moved to long-term storage 642, the bucket becomes a cold bucket. A cold bucket can become a frozen bucket after a period of time, at which point the bucket may be deleted or archived. An archived bucket cannot be searched. When an archived bucket is retrieved for searching, the bucket becomes thawed and can then be searched.

The indexing system 620 can include more than one indexer, where a group of indexers is referred to as an index cluster. The indexers in an index cluster may also be referred to as peer nodes. In an index cluster, the indexers are configured to replicate each other's data by copying buckets from one indexer to another. The number of copies of a bucket can be configured (e.g., three copies of each buckets must exist within the cluster), and indexers to which buckets are copied may be selected to optimize distribution of data across the cluster.

A user can view the performance of the indexing system 620 through the monitoring console 616 provided by the user interface system 614. Using the monitoring console 616, the user can configure and monitor an index cluster, and see information such as disk usage by an index, volume usage by an indexer, index and volume size over time, data age, statistics for bucket types, and bucket settings, among other information.

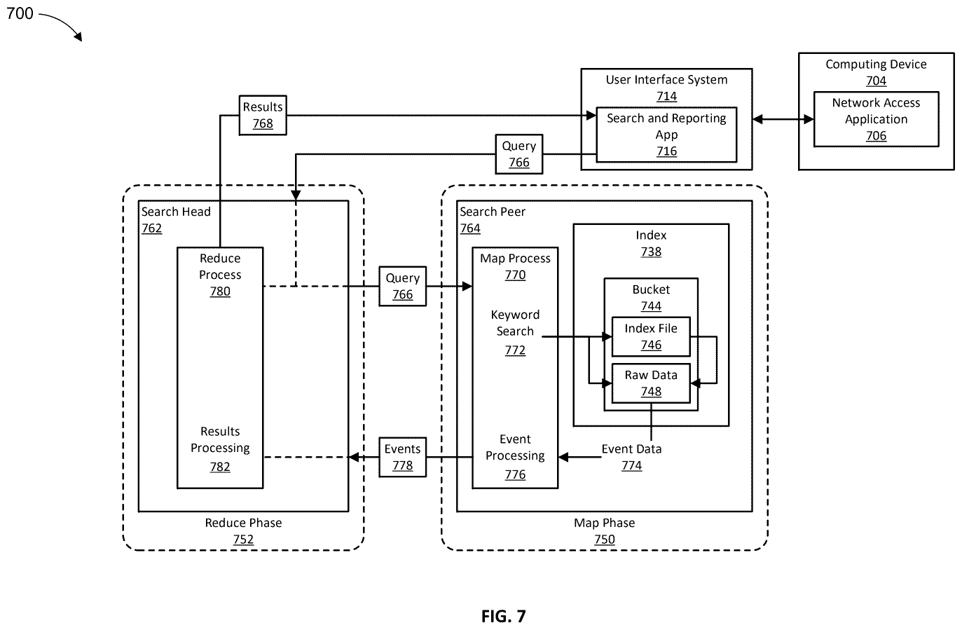

FIG. 7 is a block diagram illustrating in greater detail an example of the search system 700 of a data intake and query system, such as the data intake and query system 510 of FIG. 5. The search system 700 of FIG. 7 issues a query 766 to a search head 762, which sends the query 766 to a search peer 764. Using a map process 770, the search peer 764 searches the appropriate index 738 for events identified by the query 766 and sends events 778 so identified back to the search head 762. Using a reduce process 782, the search head 762 processes the events 778 and produces results 768 to respond to the query 766. The results 768 can provide useful insights about the data stored in the index 738. These insights can aid in the administration of information technology systems, in security analysis of information technology systems, and/or in analysis of the development environment provided by information technology systems.

The query 766 that initiates a search is produced by a search and reporting app 716 that is available through the user interface system 714 of the data intake and query system. Using a network access application 706 executing on a computing device 704, a user can input the query 766 into a search field provided by the search and reporting app 716. Alternatively or additionally, the search and reporting app 716 can include pre-configured queries or stored queries that can be activated by the user. In some cases, the search and reporting app 716 initiates the query 766 when the user enters the query 766. In these cases, the query 766 maybe referred to as an “ad-hoc” query. In some cases, the search and reporting app 716 initiates the query 766 based on a schedule. For example, the search and reporting app 716 can be configured to execute the query 766 once per hour, once per day, at a specific time, on a specific date, or at some other time that can be specified by a date, time, and/or frequency. These types of queries maybe referred to as scheduled queries.

The query 766 is specified using a search processing language. The search processing language includes commands or search terms that the search peer 764 will use to identify events to return in the search results 768. The search processing language can further include commands for filtering events, extracting more information from events, evaluating fields in events, aggregating events, calculating statistics over events, organizing the results, and/or generating charts, graphs, or other visualizations, among other examples. Some search commands may have functions and arguments associated with them, which can, for example, specify how the commands operate on results and which fields to act upon. The search processing language may further include constructs that enable the query 766 to include sequential commands, where a subsequent command may operate on the results of a prior command. As an example, sequential commands may be separated in the query 766 by a vertical line (“|” or “pipe”) symbol.

In addition to one or more search commands, the query 766 includes a time indicator. The time indicator limits searching to events that have timestamps described by the indicator. For example, the time indicator can indicate a specific point in time (e.g., 10:00:00 am today), in which case only events that have the point in time for their timestamp will be searched. As another example, the time indicator can indicate a range of time (e.g., the last 24 hours), in which case only events whose timestamps fall within the range of time will be searched. The time indicator can alternatively indicate all of time, in which case all events will be searched.

Processing of the search query 766 occurs in two broad phases: a map phase 750 and a reduce phase 752. The map phase 750 takes place across one or more search peers. In the map phase 750, the search peers locate event data that matches the search terms in the search query 766 and sorts the event data into field-value pairs. When the map phase 750 is complete, the search peers send events that they have found to one or more search heads for the reduce phase 752. During the reduce phase 752, the search heads process the events through commands in the search query 766 and aggregate the events to produce the final search results 768.

A search head, such as the search head 762 illustrated in FIG. 7, is a component of the search system 700 that manages searches. The search head 762, which may also be referred to herein as a search management component, can be implemented using program code that can be executed on a computing device. The program code for the search head 762 can be stored on a non-transitory computer-readable medium and from this medium can be loaded or copied to the memory of a computing device. One or more hardware processors of the computing device can read the program code from the memory and execute the program code in order to implement the operations of the search head 762.

Upon receiving the search query 766, the search head 762 directs the query 766 to one or more search peers, such as the search peer 764 illustrated in FIG. 7. “Search peer” is an alternate name for “indexer” and a search peer may be largely similar to the indexer described previously. The search peer 764 may be referred to as a “peer node” when the search peer 764 is part of an indexer cluster. The search peer 764, which may also be referred to as a search execution component, can be implemented using program code that can be executed on a computing device. In some implementations, one set of program code implements both the search head 762 and the search peer 764 such that the search head 762 and the search peer 764 form one component. In some implementations, the search head 762 is an independent piece of code that performs searching and no indexing functionality. In these implementations, the search head 762 may be referred to as a dedicated search head.

The search head 762 may consider multiple criteria when determining whether to send the query 766 to the particular search peer 764. For example, the search system 700 may be configured to include multiple search peers that each have duplicative copies of at least some of the event data and are implanted using different hardware resources q. In this example, the sending the search query 766 to more than one search peer allows the search system 700 to distribute the search workload across different hardware resources. As another example, search system 700 may include different search peers for different purposes (e.g., one has an index storing a first type of data or from a first data source while a second has an index storing a second type of data or from a second data source). In this example, the search query 766 may specify which indexes to search, and the search head 762 will send the query 766 to the search peers that have those indexes.

To identify events 778 to send back to the search head 762, the search peer 764 performs a map process 770 to obtain event data 774 from the index 738 that is maintained by the search peer 764. During a first phase of the map process 770, the search peer 764 identifies buckets that have events that are described by the time indicator in the search query 766. As noted above, a bucket contains events whose timestamps fall within a particular range of time. For each bucket 744 whose events can be described by the time indicator, during a second phase of the map process 770, the search peer 764 performs a keyword search 774 using search terms specified in the search query #A66. The search terms can be one or more of keywords, phrases, fields, Boolean expressions, and/or comparison expressions that in combination describe events being searched for. When segmentation is enabled at index time, the search peer 764 performs the keyword search 772 on the bucket's index file 746. As noted previously, the index file 746 includes a lexicon of the searchable terms in the events stored in the bucket's raw data 748 file. The keyword search 772 searches the lexicon for searchable terms that correspond to one or more of the search terms in the query 766. As also noted above, the lexicon incudes, for each searchable term, a reference to each location in the raw data 748 file where the searchable term can be found. Thus, when the keyword search identifies a searchable term in the index file 746 that matches a search term in the query 766, the search peer 764 can use the location references to extract from the raw data 748 file the event data 774 for each event that include the searchable term.

In cases where segmentation was disabled at index time, the search peer 764 performs the keyword search 772 directly on the raw data 748 file. To search the raw data 748, the search peer 764 may identify searchable segments in events in a similar manner as when the data was indexed. Thus, depending on how the search peer 764 is configured, the search peer 764 may look at event fields and/or parts of event fields to determine whether an event matches the query 766. Any matching events can be added to the event data #A74 read from the raw data 748 file. The search peer 764 can further be configured to enable segmentation at search time, so that searching of the index 738 causes the search peer 764 to build a lexicon in the index file 746.

The event data 774 obtained from the raw data 748 file includes the full text of each event found by the keyword search 772. During a third phase of the map process 770, the search peer 764 performs event processing 776 on the event data 774, with the steps performed being determined by the configuration of the search peer 764 and/or commands in the search query 766. For example, the search peer 764 can be configured to perform field discovery and field extraction. Field discovery is a process by which the search peer 764 identifies and extracts key-value pairs from the events in the event data 774. The search peer 764 can, for example, be configured to automatically extract the first 100 fields (or another number of fields) in the event data 774 that can be identified as key-value pairs. As another example, the search peer 764 can extract any fields explicitly mentioned in the search query 766. The search peer 764 can, alternatively or additionally, be configured with particular field extractions to perform.

Other examples of steps that can be performed during event processing 776 include: field aliasing (assigning an alternate name to a field); addition of fields from lookups (adding fields from an external source to events based on existing field values in the events); associating event types with events; source type renaming (changing the name of the source type associated with particular events); and tagging (adding one or more strings of text, or a “tags” to particular events), among other examples.

The search peer 764 sends processed events 778 to the search head 762, which performs a reduce process 780. The reduce process 780 potentially receives events from multiple search peers and performs various results processing 782 steps on the received events. The results processing 782 steps can include, for example, aggregating the events received from different search peers into a single set of events, deduplicating and aggregating fields discovered by different search peers, counting the number of events found, and sorting the events by timestamp (e.g., newest first or oldest first), among other examples. Results processing 782 can further include applying commands from the search query 766 to the events. The query 766 can include, for example, commands for evaluating and/or manipulating fields (e.g., to generate new fields from existing fields or parse fields that have more than one value). As another example, the query 766 can include commands for calculating statistics over the events, such as counts of the occurrences of fields, or sums, averages, ranges, and so on, of field values. As another example, the query 766 can include commands for generating statistical values for purposes of generating charts of graphs of the events.

The reduce process 780 outputs the events found by the search query 766, as well as information about the events. The search head 762 transmits the events and the information about the events as search results 768, which are received by the search and reporting app 716. The search and reporting app 716 can generate visual interfaces for viewing the search results 768. The search and reporting app 716 can, for example, output visual interfaces for the network access application 706 running on a computing device 704 to generate.

The visual interfaces can include various visualizations of the search results 768, such as tables, line or area charts, Chloropleth maps, or single values. The search and reporting app 716 can organize the visualizations into a dashboard, where the dashboard includes a panel for each visualization. A dashboard can thus include, for example, a panel listing the raw event data for the events in the search results 768, a panel listing fields extracted at index time and/or found through field discovery along with statistics for those fields, and/or a timeline chart indicating how many events occurred at specific points in time (as indicated by the timestamps associated with each event). In various implementations, the search and reporting app 716 can provide one or more default dashboards. Alternatively, or additionally, the search and reporting app 716 can include functionality that enables a user to configure custom dashboards.

The search and reporting app 716 can also enable further investigation into the events in the search results 716. The process of further investigation may be referred to as drilldown. For example, a visualization in a dashboard can include interactive elements, which, when selected, provide options for finding out more about the data being displayed by the interactive elements. To find out more, an interactive element can, for example, generate a new search that includes some of the data being displayed by the interactive element, and thus may be more focused than the initial search query 766. As another example, an interactive element can launch a different dashboard whose panels include more detailed information about the data that is displayed by the interactive element. Other examples of actions that can be performed by interactive elements in a dashboard include opening a link, playing an audio or video file, or launching another application, among other examples.

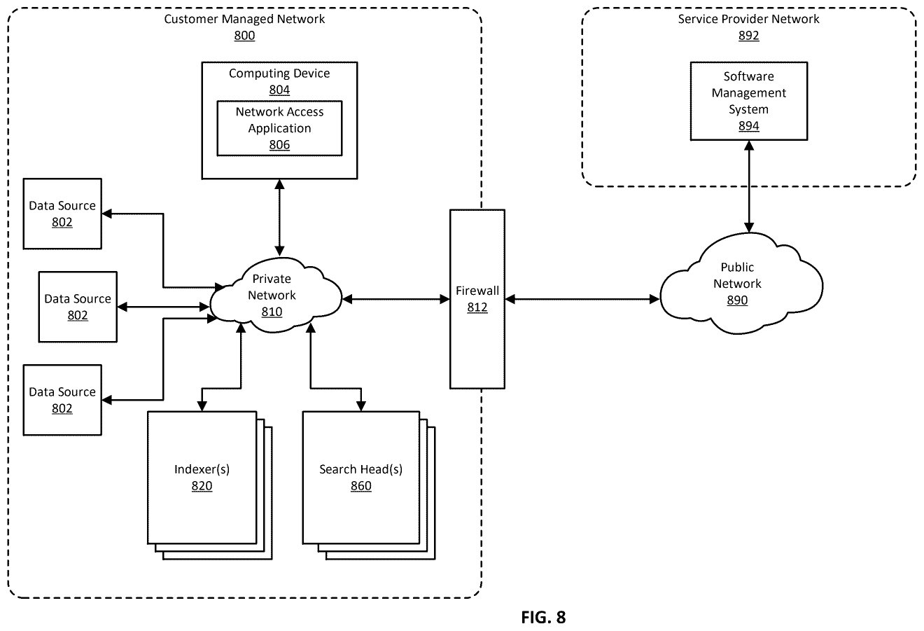

FIG. 8 illustrates an example of a self-managed network 800 that includes a data intake and query system. “Self-managed” in this instance means that the entity that is operating the self-managed network 800 configures, administers, maintains, and/or operates the data intake and query system using its own compute resources and people. Further, the self-managed network 800 of this example is part of the entity's on-premise network and comprises a set of compute, memory, and networking resources that are located, for example, within the confines of a entity's data center. These resources can include software and hardware resources. The entity can, for example, be a company or enterprise, a school, government entity, or other entity. Since the self-managed network 800 is located within the customer's on-prem environment, such as in the entity's data center, the operation and management of the self-managed network 800, including of the resources in the self-managed network 800, is under the control of the entity. For example, administrative personnel of the entity have complete access to and control over the configuration, management, and security of the self-managed network 800 and its resources.

he self-managed network 800 can execute one or more instances of the data intake and query system. An instance of the data intake and query system may be executed by one or more computing devices that are part of the self-managed network 800. A data intake and query system instance can comprise an indexing system and a search system, where the indexing system includes one or more indexers 820 and the search system includes one or more search heads 860.

As depicted in FIG. 8, the self-managed network 800 can include one or more data sources 802. Data received from these data sources may be processed by an instance of the data intake and query system within self-managed network 800. The data sources 802 and the data intake and query system instance can be communicatively coupled to each other via a private network 810.

Users associated with the entity can interact with and avail themselves of the functions performed by a data intake and query system instance using computing devices. As depicted in FIG. 8, a computing device 804 can execute a network access application 806 (e.g., a web browser), that can communicate with the data intake and query system instance and with data sources 802 via the private network 810. Using the computing device 804, a user can perform various operations with respect to the data intake and query system, such as management and administration of the data intake and query system, generation of knowledge objects, and other functions. Results generated from processing performed by the data intake and query system instance may be communicated to the computing device 804 and output to the user via an output system (e.g., a screen) of the computing device 804.

The self-managed network 800 can also be connected to other networks that are outside the entity's on-premise environment/network, such as networks outside the entity's data center. Connectivity to these other external networks is controlled and regulated through one or more layers of security provided by the self-managed network 800. One or more of these security layers can be implemented using firewalls 812. The firewalls 812 form a layer of security around the self-managed network 800 and regulate the transmission of traffic from the self-managed network 800 to the other networks and from these other networks to the self-managed network 800.

Networks external to the self-managed network can include various types of networks including public networks 890, other private networks, and/or cloud networks provided by one or more cloud service providers. An example of a public network 890 is the Internet. In the example depicted in FIG. 8, the self-managed network 800 is connected to a service provider network 892 provided by a cloud service provider via the public network 890.

In some implementations, resources provided by a cloud service provider may be used to facilitate the configuration and management of resources within the self-managed network 800. For example, configuration and management of a data intake and query system instance in the self-managed network 800 may be facilitated by a software management system 894 operating in the service provider network 892. There are various ways in which the software management system 894 can facilitate the configuration and management of a data intake and query system instance within the self-managed network 800. As one example, the software management system 894 may facilitate the download of software including software updates for the data intake and query system. In this example, the software management system 894 may store information indicative of the versions of the various data intake and query system instances present in the self-managed network 800. When a software patch or upgrade is available for an instance, the software management system 894 may inform the self-managed network 800 of the patch or upgrade. This can be done via messages communicated from the software management system 894 to the self-managed network 800.

The software management system 894 may also provide simplified ways for the patches and/or upgrades to be downloaded and applied to the self-managed network 800. For example, a message communicated from the software management system 894 to the self-managed network 800 regarding a software upgrade may include a Uniform Resource Identifier (URI) that can be used by a system administrator of the self-managed network 800 to download the upgrade to the self-managed network 800. In this manner, management resources provided by a cloud service provider using the service provider network 892 and which are located outside the self-managed network 800 can be used to facilitate the configuration and management of one or more resources within the entity's on-prem environment. In some implementations, the download of the upgrades and patches may be automated, whereby the software management system 894 is authorized to, upon determining that a patch is applicable to a data intake and query system instance inside the self-managed network 800, automatically communicate the upgrade or patch to self-managed network 800 and cause it to be installed within self-managed network 800.

Various examples and possible implementations have been described above, which recite certain features and/or functions. Although these examples and implementations have been described in language specific to structural features and/or functions, it is understood that the subject matter defined in the appended claims is not necessarily limited to the specific features or functions described above. Rather, the specific features and functions described above are disclosed as examples of implementing the claims, and other equivalent features and acts are intended to be within the scope of the claims. Further, any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and (ii) the components of respective embodiments may be combined in any manner.

Processing of the various components of systems illustrated herein can be distributed across multiple machines, networks, and other computing resources. Two or more components of a system can be combined into fewer components. Various components of the illustrated systems can be implemented in one or more virtual machines or an isolated execution environment, rather than in dedicated computer hardware systems and/or computing devices. Likewise, the data repositories shown can represent physical and/or logical data storage, including, e.g., storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Examples have been described with reference to flow chart illustrations and/or block diagrams of methods, apparatus (systems), and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics system, etc.) or other programmable data processing apparatus to produce a machine, such that the instructions, which execute via the processor(s) of the computer or other programmable data processing apparatus, create means for implementing the acts specified in the flow chart and/or block diagram block or blocks. These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

In some embodiments, certain operations, acts, events, or functions of any of the algorithms described herein can be performed in a different sequence, can be added, merged, or left out altogether (e.g., not all are necessary for the practice of the algorithms). In certain embodiments, operations, acts, functions, or events can be performed concurrently, e.g., through multi-threaded processing, interrupt processing, or multiple processors or processor cores or on other parallel architectures, rather than sequentially.

1. A computer-implemented method, comprising:
receiving, by one or more computer systems comprising one or more data processing systems, data;
generating, by the one or more computer systems, an alert object based on at least a portion of the data received from a data source that indicates an alert;
transmitting, by the one or more computer systems, the alert object to one or more alert destinations;
ingesting, by the one or more computer systems, the data;
correlating, by the one or more computer systems and after the transmitting of the alert object, the alert object with at least a portion of the data correlated to the alert to determine correlated data;
populating, by the one or more computer systems, a dashboard with at least a portion of the correlated data; and
causing, by the one or more computer systems, the dashboard to be presented on an electronic display.

2. The computer-implemented method of claim 1, further comprising analyzing at least a portion of the data to determine that the alert is indicated, wherein the data includes at least one of metric data or trace data to be indexed by the one or more computer systems.

3. The computer-implemented method of claim 2, wherein the data is associated with one of a system, a device, or a service.

4. The computer-implemented method of claim 1, further comprising providing analytics within the dashboard that indicates a root cause for the alert.

5. The computer-implemented method of claim 1, further comprising including a link to the dashboard within the alert object.

6. The computer-implemented method of claim 1, wherein the transmitting of the alert object and the correlating of the alert object with the at least the portion of the data occurs in parallel and substantially simultaneously.

7. The computer-implemented method of claim 1, wherein the correlated data is one or more of historical data obtained from a same data source associated with the alert object, or second data generated after transmitting the alert object.

8. The computer-implemented method of claim 1, further comprising updating the dashboard in response to additional data being ingested and indexed.

9. A system comprising:
one or more processors configured to:
receive data from a plurality of data sources;
generate an alert object based on at least a portion of the data that indicates an alert;
transmit the alert object to one or more alert destinations;
ingest and index the data;
correlate, after the transmitting of the alert object, the alert object with at least a portion of the data correlated to the alert to determine correlated data;
populate a dashboard with at least a portion of the correlated data; and
cause the dashboard to be presented on an electronic display.

10. The system of claim 9, further comprising analyzing at least a portion of the data to determine that the alert is indicated, wherein the data includes at least one of metric data or trace data to be indexed by the one or more computer systems.

11. The system of claim 10, wherein the data is associated with one of a system, a device, or a service.

12. The system of claim 9, further comprising providing analytics within the dashboard that indicates a root cause for the alert.

13. The system of claim 9, further comprising including a link to the dashboard within the alert object.

14. The system of claim 9, wherein the transmitting of the alert object and the correlating of the alert object with the at least the portion of the data occurs in parallel and substantially simultaneously.

15. The system of claim 9, wherein the correlated data is one or more of historical data obtained from a same data source associated with the alert object or second data generated after generating the alert object.

16. The system of claim 9, further comprising updating the dashboard in response to additional data being ingested and indexed.

17. A non-transitory computer-readable medium storing a set of instructions, the set of instructions when executed by one or more processors cause processing to be performed comprising:
receiving, by one or more computer systems comprising one or more data processing systems, data;
generating, by the one or more computer systems, an alert object based on at least a portion of the data received from a data source that indicates an alert;
transmitting, by the one or more computer systems, the alert object to one or more alert destinations;
ingesting, by the one or more computer systems, the data;
correlating, by the one or more computer systems and after the transmitting of the alert object, the alert object with at least a portion of the data correlated to the alert to determine correlated data;
populating, by the one or more computer systems, a dashboard with at least a portion of the correlated data; and
causing, by the one or more computer systems, the dashboard to be presented on an electronic display.

18. The non-transitory computer-readable medium of claim 17, the processing further comprising analyzing at least a portion of the data to determine that the alert is indicated, wherein the data includes at least one of metric data or trace data to be indexed by the one or more computer systems.

19. The non-transitory computer-readable medium of claim 17, the processing further comprising providing analytics within the dashboard that indicates a root cause for the alert.

20. The non-transitory computer-readable medium of claim 17, the processing further comprising including a link to the dashboard within the alert object.
